(19) United States
(12) Patent Application Publication
(10) Pub. No.: US 2024/0385033 A1
(43) Pub. Date: Nov. 21, 2024

(54) Raman Photometer for Simultaneous Multi-Component Analysis, Measuring System and Computer Program Product

(71) Applicant: Siemens Aktiengesellschaft, München (DE)

(72) Inventors: Konstantin HAAR, Karlsruhe (DE); Camiel HEFFELS, Stutensee-Buechig (DE)

(21) Appl. No.: 18/689,525

(22) PCT Filed: Aug. 30, 2022
(86) PCT No.: PCT/EP2022/074042

§ 371 Date: Mar. 6, 2024

(30) Foreign Application Priority Data
Sep. 9, 2021 (EP) 21195664.4

(51) Int. Cl. G01J 1/04; G01J 3/44; G01N 21/65

(52) U.S. Cl. CPC G01J 1/0492; G01J 3/44; G01N 21/65; G01N 2021/651; G01N 2201/0245

(57) ABSTRACT

An analysis unit, a computer program product and a Raman photometer that includes a base module having a measuring cell that generates Raman radiation that is emitted through a substance sample and includes at least one expansion module having at least a first semi-permeable interference filter used to simultaneously detect a first and second components of the substance sample, where a corresponding method for measuring the composition of the substance sample is implemented via the Raman photometer, and where an analysis unit is configured to perform the method, and to a spectrometer system which comprises a Raman photometer according to the invention.

### CROSS-REFERENCE TO RELATED APPLICATIONS

This is a U.S. national stage of application No. PCT/EP2022/074042 filed 30 Aug. 2022. Priority is claimed on European Application No. 21195664.4 filed 9 Sep. 2021, the content of which is incorporated herein by reference in its entirety.

### BACKGROUND OF THE INVENTION

### 1. Field of the Invention

The invention relates to a Raman photometer for simultaneous multi-component analysis of a substance sample, a measuring system having such a Raman photometer at its disposal, and relates to a computer program product for simulating an operating behavior of the Raman photometer.

### 2. Description of the Related Art

US Pub. No. 2007/0285658 A1 discloses a Raman photometer which is configured to allow an accelerated detection of a plurality of components of a sample. To this end, the Raman photometer has a light conductor via which a beam path comprising Raman radiation is conducted to a rotatable prism. With the rotatable prism, the beam path is conducted successively to a plurality of band-pass filters. The band-pass filters are coupled to a single optical detector that successively captures the filtered beam paths provided. The principle of time-multiplexing is realized thereby.

It is necessary in various industrial processes to monitor the composition of substance samples having a multiplicity of components. For the purposes of closed-loop control and open-loop control in such industrial processes, such as chemical or pharmaceutical manufacturing processes or even the monitoring of exhaust gases, rapid determination of the composition of a monitored process medium is preferred. At the same time, devices that are suitable for this purpose must be readily modifiable.

### SUMMARY OF THE INVENTION

It is an object of the invention to provide an apparatus for determining a composition of a substance sample, where the apparatus comprising an improvement in at least one of the points illustrated.

This and other objects and advantages are achieved in accordance with the invention by a Raman photometer comprising a base module and an expansion module. The base module contains a measuring cell in which a substance sample can be held whose composition must be determined. The substance sample can be enclosed in the measuring cell or flow through the measuring cell during operation. The substance sample can comprise a gas mixture, liquids and/or solids. During operation of the Raman photometer, the substance sample can be irradiated in the measuring cell such that a Raman radiation is produced by the substance sample, characterizing the composition thereof. The Raman radiation comprises the so-called Stokes-Raman radiation and so-called Anti-Stokes-Raman radiation, these being produced as a result of an inelastic scattering of molecules of the substance sample. The Raman radiation generated in the measuring cell travels optically in a beam path into the at least one expansion module that is connected to the base module. The expansion module is used to capture the incident Raman radiation in order thus to ascertain the composition of the substance sample. In accordance with the invention, the expansion module has at least one first semi-permeable interference filter that the Raman radiation can partly penetrate and is partly reflected by. That part of the Raman radiation that penetrates the first interference filter is characteristic of a first component of the substance sample. The reflected part of the Raman radiation in turn comprises a section that is characteristic of a second component of the substance sample. Both portions propagate optically and are essentially simultaneously available for evaluation. The first semi-permeable interference filter is therefore inventively used to capture the first and second components of the substance sample simultaneously.

By virtue of the first semi-permeable interference filter in the inventive Raman photometer, measured signals for the first and second component are available for immediate evaluation during operation. The substance sample can therefore be irradiated multiple times in a shorter interval in order to obtain additional measured values for the composition. As a consequence, it is possible rapidly to determine the composition of the substance sample. In comparison with conventional gas chromatographs, which require minutes for a measuring routine, the composition of the substance sample can be captured in less than 60 seconds using the inventive Raman photometer. The achievable sampling rate is limited solely by the time required to exchange the substance sample in the measuring cell. Thus, the inventive Raman photometer realizes the principle of a Raman photometer with parallel processing.

Using further expansion modules attached to the base module, it is possible to increase the number of components of the substance sample that can be captured simultaneously. By virtue of its increased sampling rate, the inventive Raman photometer is also suitable for rapidly measuring complex substance samples comprising a multiplicity of components in respect of composition. This allows the inventive Raman photometer to be used in the closed-loop control and open-loop control of industrial processes, in particular chemical processes that are sensitive to the composition of a process medium, such as in the manufacture of medicines. Furthermore, a slot diaphragm is inventively arranged between the measuring cell and the first semi-permeable interference filter. With the slot diaphragm, spatial filtering of the Raman radiation generated in the measuring cell is achieved. The slot diaphragm also serves to reduce a background signal, such as a background noise, at least in the first receiving device during a measuring operation.

In an embodiment of the disclosed Raman photometer, at least the first receiving device can be formed to essentially have the shape of a strip. At least the first receiving device is arranged in the at least one expansion module. The strip shape corresponds to the spatially filtered Raman radiation, so that a smaller receiving area is required for this. During operation of the respective receiving device, a received dark signal portion is reduced. Cooling capacity required for continuous operation is reduced in the case of the respective receiving devices.

In an embodiment of the disclosed Raman photometer, the first interference filter is formed as a band-pass filter for a first Raman band. A Raman band is understood here to be a wavelength range in which Raman radiation occurs with a specific substance. A band-pass filter realizes the principle of a semi-permeable interference filter in a simple manner. The Raman band, for which the first interference filter is permeable, can be captured via the first receiving device, this being assigned to the first interference filter, i.e., being optically downstream thereof. The first interference filter and the first receiving device are selected such that a shift in the central wavelength of the incident Raman band is taken into account. The first receiving device can be configured in particular to quantify the received first Raman band and thereby to determine a concentration of the first component of the substance sample. By selecting the first interference filter, it is therefore possible to specify which Raman band must be captured by the first receiving device. A suitable receiving device for this wavelength range and anticipated intensity of the Raman band can be selected accordingly. Technical compromises that are required in order to be able to measure a plurality of Raman bands with sufficient accuracy are consequently unnecessary. In particular, in comparison with conventional Raman photometers, slit diaphragms that are used to reduce the intensities of the Raman bands to be captured are unnecessary. Furthermore, an evaluation of the measured signals that are captured by the first receiving device can focus on only one anticipated Raman band, thereby allowing simplified and hence accelerated processing of the measured signals. For example, a particularly precise evaluation can be effected using so-called multilinear regression. It is consequently possible in a simple way to achieve greater measuring accuracy for the first component. This is transferable to further receiving devices and further semi-permeable interference filters in the expansion module.

Furthermore, the first interference filter can be configured to reflect the beam path of the Raman radiation which lies outside the first Raman band. To this end, the first interference filter can be oriented obliquely in relation to the beam path. The reflected beam path is directed by the first interference filter to a second semi-permeable interference filter that is arranged in the expansion module. In a similar manner to the first interference filter, the second interference filter is permeable for a second Raman band. A second receiving device is assigned to the second interference filter, i.e., optically downstream thereof, such that the second Raman band can be captured by the second receiving device. In particular, the second interference filter can be formed as a band-pass filter. The second Raman band is characteristic of a second component of the substance sample, such that the concentration thereof can be captured by means of the second receiving device. In a similar manner to the first receiving device, the second receiving device can also be selected specifically to allow precise capture of the second Raman band. The principle of allowing Raman bands that pass through a band-pass filter to a receiving device to penetrate while reflecting the other Raman radiation to a further interference filter is easily scalable. The scalability is essentially limited by the structural space available at the expansion module and the dimensions of the receiving devices.

In a further embodiment of the disclosed Raman photometer, the expansion module thereof has at least three receiving devices. Three receiving devices can be attached on a plane in a space-saving manner in the case of an essentially cuboid basic shape of the expansion module. Alternatively, the expansion module can be connected to the base module on one side and equipped with five receiving devices that are essentially arranged on the remaining cuboid faces. In a further alternative, as a basic shape, the base module can have any polyhedral shape defining the faces to which expansion modules can be attached. The at least three receiving devices in the disclosed Raman photometer can easily be accessed from the outside, thereby allowing rapid and simple maintenance, particularly with regard to modular exchange of receiving devices. As a result of the separate evaluation of individual Raman bands by individually assigned receiving devices, defects in these or their assigned interference filters can be identified in a targeted manner, thereby simplifying any repairs. The structure outlined here likewise allows rapid modification of the Raman photometer. Its structure can therefore be varied in an application-oriented manner.

Furthermore, at least one of the receiving devices in the disclosed Raman photometer can be formed as a photodetector, for example, a photomultiplier or microphotomultiplier. These make it possible to detect individual photons and therefore offer a high degree of sensitivity when measuring a Raman band. As a result of the interference filters being semi-permeable, only limited radiation incidence on the photodetector can be expected and therefore this sensitivity is extremely useful. Furthermore, the measuring period can be minimized in the case of such a receiving device. The at least one receiving device, formed as a photodetector, can also have a cooling system via which so-called detector noise can be reduced in the case of raised ambient temperatures. The cooling system in this case can comprise an active cooling component such as nitrogen cooling, a Peltier element, a fan and/or passive cooling components such as cooling fins or a heat sink. The receiving device in this case can be form, for example, as a photomultiplier. The invention is based inter alia on the surprising finding that a loss of heat into the ambient air is also sufficient for long-term operation. The disclosed Raman photometer can therefore be manufactured to be space-saving and cost-efficient. As an alternative, the photodetector can also be formed as an avalanche photodiode, an electron multiplying CCD (EMCCD), a single-photon avalanche diode (SPAD), or an avalanche diode in Geiger mode (GAPD). At low intensities of the corresponding Raman bands, receiving devices can be deployed that are suitable for counting photon pulses. In the case of high concentrations of the components of the substance sample, or in the case of a substance sample comprising a liquid or a solid, the receiving device can be configured to capture a photon flux.

Furthermore, the measuring cell in the base module can be configured such that the beam path generated by the Raman radiation radiates, i.e., emerges, from the measuring cell essentially perpendicular to a beam direction of an excitation light source. The excitation light source is connected to the base module and is configured to irradiate the substance sample directly. It is possible via the irradiation to produce a virtual energy level transition in molecules of the substance sample, thereby generating the Raman radiation and a Rayleigh radiation. A light trap, via which scattered light from wall reflections can be reduced, is arranged on the opposite side of the base module to the excitation light source. A background signal can be reduced thereby. The excitation light source can be attached to a side face of the base module, where good accessibility is provided, for example, for a repair operation. The Raman radiation to be analyzed and the Rayleigh radiation that must be suppressed are essentially perpendicular to the beam direction of the excitation light source. The Rayleigh radiation can easily be filtered out by means of a cut-off filter, for example. The Raman radiation that is emitted perpendicularly to the beam direction of the excitation light source is therefore to a great extent free from interference effects, thus allowing greater measuring accuracy. Alternatively or additionally, the measuring cell can also be configured to be pressure-resistant in the sense of explosion protection. This allows analysis of substance samples at pressures that are higher than the ambient air pressure. The higher the pressure in the substance sample, the higher the intensities that can be attained for the Raman radiation which is generated. This makes it possible to achieve greater measuring accuracy in the case of components of the substance sample which are present in reduced concentration, for example.

In a further embodiment of the disclosed Raman photometer, the excitation light source is formed as a laser, in particular a laser having a central wavelength from 350 nm to 450 nm. A central wavelength of this type lies in the spectrum of visible light, for example, in a range from violet to blue. The at least one interference filter can therefore be formed as a simple glass lens system. This means that sophisticated components such as quartz lens systems are not required. Lasers having a wavelength of this type are also used in other technical fields, for example, in additive manufacturing or in biomedicine and are consequently readily available and cost-efficient. Furthermore, lasers having such a central wavelength are particularly effective for generating Raman radiation, because the intensity of Raman radiation is indirectly proportional to the fourth power of its excitation wavelength. With a laser having a central wavelength of 402 nm, for example, Raman bands having central wavelengths from 410 nm to 490 nm can be achieved for hydrogen, nitrogen, carbon dioxide, oxygen, methane, ethane, propane, n-butane and water. These can then in turn be unambiguously distinguished with ease and reliable measurement is therefore guaranteed. Likewise, the use of expensive or larger excitation light sources as per the prior art, such as HeNe lasers, is unnecessary.

Furthermore, at least the first interference filter can have a half width of up to 20 nm, in particular up to 10 nm, around a central wavelength. A half width defines a wavelength window around the central wavelength of the respective interference filter, in which this is permeable. Interference filters can easily be manufactured with precise half widths, and therefore the semi-permeability of the first interference filter can be adjusted precisely. Furthermore, interference filters, which therefore realize the principle of a band-pass filter, can be manufactured in defined form as spare parts. In particular, band-pass filters of this type are deployed in other technical fields and are produced in volume. Accordingly, the band-pass filters outlined here offer cost-efficient availability. At least the first interference filter is therefore easily exchangeable. This allows simple repair of the disclosed Raman photometer. Likewise, the expansion module of the Raman photometer can quickly be adapted to a different Raman band by exchanging an interference filter. Thus, the disclosed Raman photometer can easily be converted for other use cases.

Furthermore, the disclosed Raman photometer can comprise at least one semi-permeable interference filter having a central wavelength from 350 nm to 555 nm. This spectrum likewise lies in the segment of visible light and can easily be captured by the receiving device. In particular, excitation of the substance sample via a laser having a central wavelength from 350 nm to 550 nm allows Raman radiation to be generated in the range from 350 nm to 555 nm. In this range, individual components of the substance sample can be unambiguously distinguished.

Equally, in the case of the disclosed Raman photometer, the base module can be attached to from two to six expansion modules. At least one of the expansion modules can be coupled to the base module in a non-destructively detachable manner in this case. Three receiving devices can readily be attached to each expansion module. As a result, it is easily possible in the case of six expansion modules to examine substance samples with up to 18 components, essentially instantaneously, with respect to composition. It is alternatively also possible for at least one expansion module to have a beam path exit, so that the incident Raman radiation can be directed into a further expansion module. In this way, the disclosed Raman photometer can be extended further.

The objects an advantages in accordance with the invention are equally achieved by a method via which a composition of a substance sample is measured. To this end, a substance sample having a plurality of components is provided in a Raman photometer. In a first step of the method, the substance sample is irradiated by an excitation light source. A Raman radiation that can comprise the so-called Stokes-Raman radiation and Anti-Stokes-Raman radiation is generated by the irradiation. The Raman radiation is emitted by the substance sample and propagates in an essentially optical manner. In a second step, a beam path of the emitted Raman radiation is optically directed onto a first interference filter. This optical direction can be effected via a diaphragm, a lens and other optical elements. In a third step, the beam path from the second step strikes the first interference filter. In the third step, part of the Raman radiation is let through by the first interference filter to a first receiving device. The first receiving device is configured to capture a first Raman band. In a fourth step, which is executed essentially simultaneously with the third step, the remaining Raman radiation at the first interference filter is at least partially reflected to a second interference filter. That portion that cannot pass through to the first receiving device in the third step is therefore at least partially reflected onward. In accordance with the invention, the second interference filter is connected optically upstream of a second receiving device, which is configured to capture a second Raman band. Owing to the optical propagation of the beam path with the Raman radiation, the first and second Raman bands arrive respectively at the first and second receiving devices essentially simultaneously. The first and second Raman bands are characteristic of a first and second component of the substance sample, which can therefore be measured separately with greater precision. The receiving devices are configured to capture an intensity of the incident Raman band, thereby allowing a concentration of the respective component to be derived. With the method in accordance with the invention, even complex substance samples comprising a multiplicity of components can be examined quickly and accurately with respect to their composition. With the semi-permeable first interference filter, the inventive method is based on a relatively simple passive component. The concept of a Raman photometer with parallel processing is realized in a surprisingly simple manner accordingly. Therefore, essentially simultaneously measured signals can be provided via the first and second receiving devices for evaluation by an evaluation unit of the Raman photometer. The processing power of evaluation units today can be exploited in a technically beneficial way by these simultaneously measured signals. In particular, using the inventive method, real-time capability can be achieved for a wide range of use cases. This allows in particular open-loop control and closed-loop control of industrial processes with a sensitive process medium. The inventive method can be performed in particular via a Raman photometer as disclosed in accordance with one of the above-disclosed embodiments. The technical aspects of the Raman photometer are therefore readily transferable either separately or in combination to the outlined method.

In an embodiment of the disclosed method, the capture of the first Raman band by the first receiving device and the capture of the second Raman band by the second receiving device take place essentially simultaneously. Consequently, measured signals are generated by the first and second receiving devices simultaneously, and transferred to an evaluation unit. It is alternatively possible in the disclosed embodiment of the method to also direct further Raman bands separately via a third, fourth, etc. interference filter likewise to a third, fourth, etc. receiving device. The disclosed method is therefore readily scalable.

The underlying objects and advantages in accordance with the invention are also achieved by an inventive evaluation unit that is configured for use in a spectrometer system. The spectrometer is configured to capture a composition of a substance sample and has a Raman photometer for this purpose. The evaluation unit is inventively configured to receive and evaluate measured signals from at least two receiving devices of the Raman photometer simultaneously. In particular, the evaluation unit can be configured to implement a method in accordance with the above-disclosed embodiments, i.e., to determine a composition of the substance sample based on measured signals that are generated essentially simultaneously by the receiving devices of the Raman photometer. In particular, the evaluation unit can be configured for connection to a Raman photometer in accordance with the above-disclosed embodiments. For the purpose of implementing the disclosed method, the evaluation unit can have an evaluation program via which the received measured signals are processed. Furthermore, the evaluation unit can have an artificial intelligence that is trained using a training data set. The measured values derived from the measured signals have a degree of measurement inaccuracy, being therefore subject to a tolerance range. The measurement relating to composition can be further refined, i.e., made more precise, via the artificial intelligence.

The objects and advantages in accordance with the invention are likewise achieved by an inventive spectrometer system which is designed to determine a composition of a substance sample. The spectrometer system comprises a Raman photometer and an evaluation unit which is connected thereto. The Raman photometer is inventively configured in accordance with the above-disclosed embodiments. Further to this, the evaluation unit can also be configured in accordance with the above-disclosed embodiments. The inventive spectrometer system offers an increased sampling rate for capturing the composition of the substance sample. Thus, a substance sample can be monitored essentially in real time overall with respect to its composition. The disclosed spectrometer system is therefore suitable for monitoring industrial processes that include a sensitive process medium.

Furthermore, the underlying objects and advantages in accordance with the invention are achieved by an inventive computer program product, which is particularly configured, for simulating an operating behavior of a Raman photometer. The computer program product can comprise instructions which, when the computer program is executed by a computer including a processor and memory, cause the computer to simulate the operating behavior of the Raman photometer. For the purpose of simulating the operating behavior of the Raman photometer, the computer program product has a physics module which, at least for the purpose of simulating a reflection behavior and a transmission behavior of an interference filter, is irradiated by Raman radiation. The physics module can also be configured to replicate a reaction behavior of at least one receiving device that is arranged behind such an interference filter. To this end, the Raman photometer to be simulated can be at least partially reproduced in the claimed computer program, for example, in its structural shape and/or in the way it functions. Alternatively or additionally, the Raman photometer can also be configured as a mathematical model in the physics module. The physics module is configured to replicate the operating behavior of the Raman photometer under adjustable operating conditions. The adjustable operating conditions include, for example, a composition of a substance sample, a changeability of this composition, a central wavelength of an excitation light source, the power of the excitation light source, and/or a temperature-dependent transmission and reflection behavior of semi-permeable interference filters. The computer program product can have a data interface via which corresponding data can be specified via user input and/or other simulation-related computer programs. Likewise, the computer program product can have a data interface for outputting simulation results to a user and/or other simulation-related computer program products. It is possible via the computer program product to identify, for example, a defective interference filter, an incorrectly aligned interference filter and/or a defective receiving device in the Raman photometer itself, an incorrect mounting of a expansion module and/or a malfunction in an equipment process from which the substance sample is taken. The disclosed computer program product is therefore established to provide error diagnosis for a Raman photometer according to the invention and/or an associated equipment process. For this purpose, the Raman photometer to be simulated can be configured in accordance with the above-disclosed embodiments. In particular, the computer program product can simulate a Raman radiation that is filtered by the slot diaphragm and therefore has a reduced background noise. Furthermore, the interference filter reduces the load on each receiving device, because each receiving device is provided with information that is more rigorously selected. A simulated capture of Raman radiation that has been simulated thus and has been filtered via the slot diaphragm and at least the first interference filter also requires only a simplified simulated evaluation. The inventive computer program product can be performed with reduced computing effort accordingly. This in turn allows the disclosed computer program product to be executed at higher speed. Consequently, the computer program product is suitable for essentially real-time simulation of the underlying Raman photometer. The term real time in this context is understood in the sense of the underlying use and the associated requirements for real-time capability, for example, in a petrochemical plant. It is likewise possible via the disclosed computer program product to perform improved monitoring of the underlying Raman photometer, thereby allowing faster identification of defects in the Raman photometer and thus increasing the operating safety of a plant in which the Raman photometer is deployed. The underlying Raman photometer, whose operating behavior can be simulated by the inventive computer program product, realizes the principle of a Raman photometer with parallel processing. Accordingly, the components to be included in the simulation can also be monitored in parallel. In particular, their respective operating behaviors have a reduced degree of reciprocal dependency. For example, the simulated operating behavior of a receiving device essentially depends solely on the interference filter that is arranged immediately ahead of it. Corresponding to this functional parallel processing, the inventive computer program product can surprisingly also be executed in the form of parallel individual processes. Accordingly, the inventive computer program product can run at sufficient speed even with reduced processing power. In particular, the inventive computer program product can offer real-time capability, for example, for real-time monitoring of a simulated Raman photometer. More detailed requirements that define the real-time capability are derived in this context, for example, from an equipment process into which the Raman photometer can be integrated. It is moreover also possible via the inventive computer program product to monitor a plurality of Raman photometers in a practical manner in the context of an equipment process.

The computer program product can be formed as a so-called digital twin as described in the publication US 2017/286572 A1, for example, the disclosure of which is incorporated herein by reference in its entirety.

The computer program product can be monolithic, i.e., executable entirely on one hardware platform. Alternatively, the computer program product can be modular and comprise a plurality of subprograms that can be executed on separate hardware platforms and interact via a communicative data connection. Such a communicative data connection can be a network connection or an internet connection. Furthermore, the inventive computer program product can test and/or optimize a Raman photometer or a spectrometer system via simulation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below with reference to individual embodiments in figures. The figures are reciprocally cross-referential in that the same reference signs have the same technical significance in different figures. The features of the different embodiments can be combined with each other and with the features outlined above, in which:

FIG. 1 shows a sectional plan view of the structure of a first embodiment of the spectrometer system in accordance with the invention;

FIG. 2 shows a sectional detailed plan view of an expansion module of the spectrometer system of FIG. 1;

FIG. 3 shows a diagram relating to a stage of an embodiment of the method in accordance with the invention; and

FIG. 4 is a flowchart of the method in accordance with the invention.

### DETAILED DESCRIPTION OF THE EXEMPLARY EMBODIMENTS

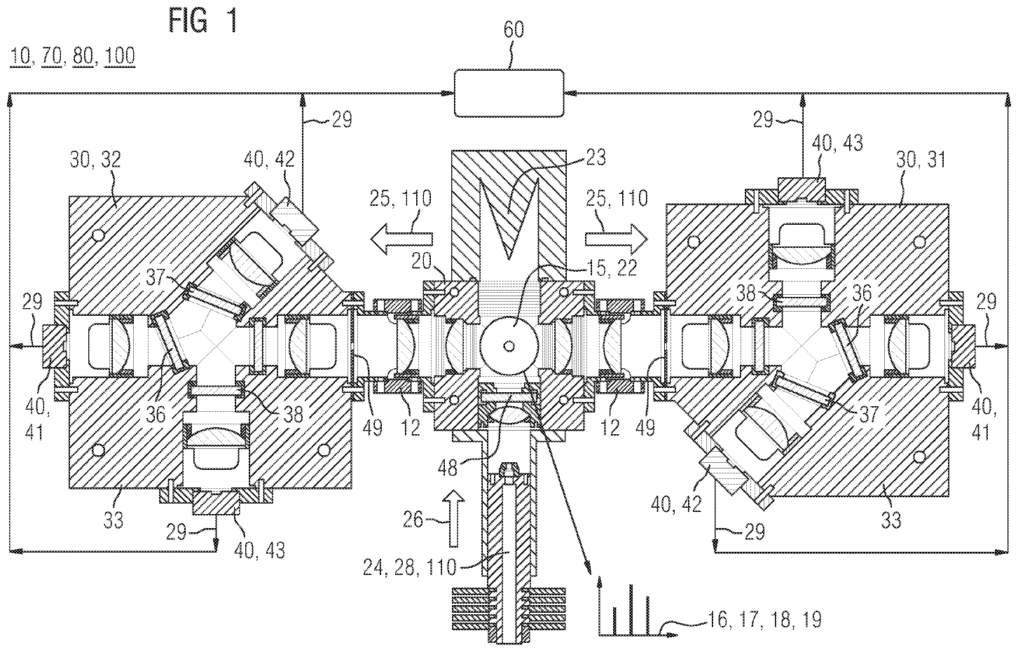

The structure of an embodiment of a disclosed spectrometer system 70 comprising a Raman photometer 10 coupled to an evaluation unit 60 is shown in a sectional plan view in FIG. 1. The Raman photometer 10 here is at a stage of a method 100 for determining a composition 19 of a substance sample 15, where Raman photometer 10 is configured for the performance thereof. The Raman photometer 10 has a base module 20 containing a measuring cell 22 into which the substance sample 15 is introduced. The base module 20 can be configured to be pressure-resistant in the sense of explosion protection, so that substance samples 15 having a higher than ambient air pressure can also be analyzed. The higher the pressure in the substance sample 15, the higher the intensities that can be captured. The substance sample 15 comprises a first, second and third component 16, 17, 18 whose respective concentrations are to be ascertained by the method 100. The base module 20 has an excitation light source 24 which is formed as a laser 28 and that is suitable for irradiating the substance sample 15 in a first step 110. In order to increase the beam quality of the laser 28, arranged in the base module 20 is a prefilter 48 that is configured as a band-pass filter and that is permeable in the range of a central wavelength 54 of the laser 28. A Raman radiation 25 emitted by the substance sample 15 is produced as a result of irradiating the substance sample 15 with the excitation light source 24. For scattering of a light beam of the excitation light source 24, the base module 20 has a light trap 23 in a region opposite the excitation light source 24. The light trap 23 can be configured to increase an intensity of the Raman light in the base module 20 by a factor of approximately two.

The generated Raman radiation 25 propagates mainly essentially perpendicularly to the beam direction 26 of the excitation light source 24 and arrives at expansion modules 30 that are connected to the base module 20. The expansion modules 30 belong to the Raman photometer 10 and each have a main body 33 that is detachably connected to the base module 20 via a coupling element 12. The base module 20 has a first expansion module 31 that is arranged opposite a second expansion module 32. Arranged in the first expansion module 31 are a first, second and third interference filter 36, 37, 38, each of which is configured to be semi-permeable. Part of the incident Raman radiation 25 arriving in the first expansion module 31 is let through by the interference filters 36, 37, 38 to a receiving device 40 that is arranged optically downstream accordingly. Raman radiation 25 let through by the first interference filter 36 therefore arrives at a first receiving device 41, Raman radiation 25 let through by the second interference filter 37 arrives at a second receiving device 42 and Raman radiation 25 let through by a the third interference filter 38 arrives at a third receiving device 43. The receiving devices 40 are each configured to generate a measured signal 29 that corresponds to the received Raman radiation 25 and that is transferred to the evaluation unit 60.

The Raman photometer 10 also has a second expansion module 32 that corresponds substantially to the first expansion module 31 in its structure but is not identical. In particular, the interference filters 36, 37, 38 in the first and second expansion module 31, 32 differ in their respective configurations. The interference filters 36, 37, 38 in the first and second expansion modules 31, 32 are configured to capture different components of the substance sample 15. The Raman photometer 10 in accordance with FIG. 1 is therefore suitable for separately capturing six different components in the substance sample 15. The operating behavior of the Raman photometer 10 according to FIG. 1 can be simulated by a computer program product 80, which is not shown in detail. The computer program product 80 is formed as a digital twin of the Raman photometer 10 here.

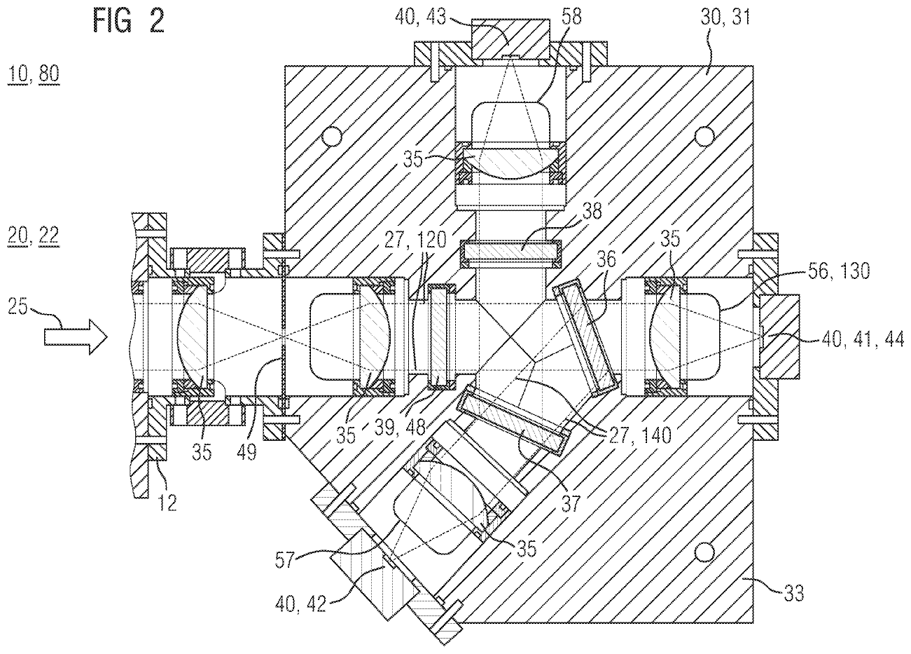

The first expansion module 31 of a Raman photometer 10 in accordance with FIG. 1 is shown in a detail view in FIG. 2. The Raman radiation 25 produced in the measuring cell 22 of the base module 20 propagates through the coupling element 12 and a slot diaphragm 49 into the first expansion module 31. With the slot diaphragm 49, part of the Raman radiation 25 generated in a central section of the measuring cell 22 is directed into the first expansion module 31. The propagation of the Raman radiation 25 occurs in the form of a beam path 27 that can be optically directed via corresponding lenses 35. The beam path 27 is also directed through an optical filter 39, via which the Raman radiation 25 can be prefiltered and which is configured for this purpose as a cut-off filter, for example. In a second step 120 of the method 100, the beam path 27 is optically directed to the first interference filter 36, this being semi-permeable and being formed as a band-pass filter. Part of the beam path 27 of the Raman radiation 25, said part comprising a first Raman band 56, penetrates the first interference filter 36 and in a third step 130 arrives via a lens 35 at first receiving device 41, which is configured as a photodetector 44. The receiving device 41 is configured to detect and quantitatively capture Raman radiation 25 in a wavelength range that corresponds to the first Raman band 56. An intensity of the Raman radiation 25 in the range of the first Raman band 56 corresponds to a concentration of the first component 16 of the substance sample 15, as illustrated in FIG. 1. The first receiving device 41 is therefore used to measure the first component 16 of the substance sample 15.

In order to let through the Raman radiation 25 in a range of the first Raman band 56, the first interference filter 36 in the main body 33 is arranged so as to be angled relative to the incident beam path 27. With the angled arrangement of the first interference filter 36, that part of the Raman radiation 25 that was not let through in the third step 130 is reflected in a fourth step 140 of the method 100. The at least partially reflected Raman radiation 25 is therefore, as shown by the corresponding beam path 27, directed to the second interference filter 37. In a similar manner to the first interference filter 36, the second interference filter 37 is also semi-permeable. Raman radiation 25 in the range of a second Raman band 57 penetrates the second interference filter 37 and is directed via a lens 35 to a second receiving device 42. Corresponding to the first receiving device 41, the second receiving device 42 is configured to quantitatively capture Raman radiation 25 in the wavelength range of the second Raman band 57. The intensity of the Raman radiation 25 in the wavelength range of the second Raman band 57 is a measure of the concentration of the second component 17 of the substance sample 15, as shown in FIG. 1. In a similar manner to the first interference filter 36, the second interference filter 37 is also oriented in the main body 33 so as to be angled relative to the incident beam path 27. That part of the Raman radiation 25 that lies outside the second Raman band 57 is directed to a third interference filter 38.

The third interference filter 38 is likewise configured to be semi-permeable. In particular, the third interference filter 38 is configured to let through Raman radiation 25 in the range of a third Raman band 58. A third receiving device 43 is arranged optically behind the third interference filter 38 and is configured to quantitatively capture Raman radiation 25 in the wavelength range of the third Raman band 58. The intensity of the Raman radiation 25 in the wavelength range of the third Raman band 58 is a measure of the concentration of the third component 18 of the substance sample 15, as illustrated in FIG. 1.

As a result of the optical propagation of the Raman radiation 25 along the beam path 27, the receiving devices 40, i.e., the first, second and third receiving devices 41, 42, 43, can be operated simultaneously. At least the first and second Raman bands 56, 57 can be received and captured essentially simultaneously by the first and second receiving devices 41, 42 respectively. In order to achieve this, the first step 110 of the method 100, as shown in FIG. 1, and the second, third and fourth steps 120, 130, 140 can be carried out essentially simultaneously. Accordingly, at least the first and second components 16, 17 of the substance sample 15 can be captured simultaneously, at least with respect to concentration. The principle of a Raman photometer 10 with parallel processing is thereby realized. At least the first and second components 16, 17 of the substance sample 15 can be captured essentially in real time in the first expansion module 31. Furthermore, the receiving devices 40 can be accessed and exchanged separately from the outside. The first expansion module 31 can not only be exchanged as a whole, but can also be repaired singly in a modular manner. Furthermore, the first expansion module 31 can also be adapted for other anticipated compositions 19 of the substance sample 15 by exchanging receiving devices 40. With the first expansion module 31 in accordance with FIG. 2, it is possible in total to capture a first, second and third component 16, 17, 18 of the substance sample 15 simultaneously. The functional principle of the first expansion module 31 can be transferred analogously to the second expansion module 32 of the Raman photometer 10 in accordance with FIG. 1. By selecting corresponding interference filters 36, 37, 38 and receiving devices 40 in the first and second expansion modules 31, 32, it is possible thereby to capture a total of six different components of the substance sample 15 simultaneously. The reflection behavior and transmission behavior of the beam path 27 of the Raman radiation 25 at the interference filters 36, 37, 38 in an expansion module 30 is part of the operating behavior of the associated Raman photometer 10. The reception behavior of the receiving devices 40 is likewise part of the operating behavior of the Raman photometer 10. The operating behavior can be simulated via a computer program product 80, which is not shown in greater detail. For this purpose, the computer program product 80 is formed as a digital twin of the Raman photometer 10.

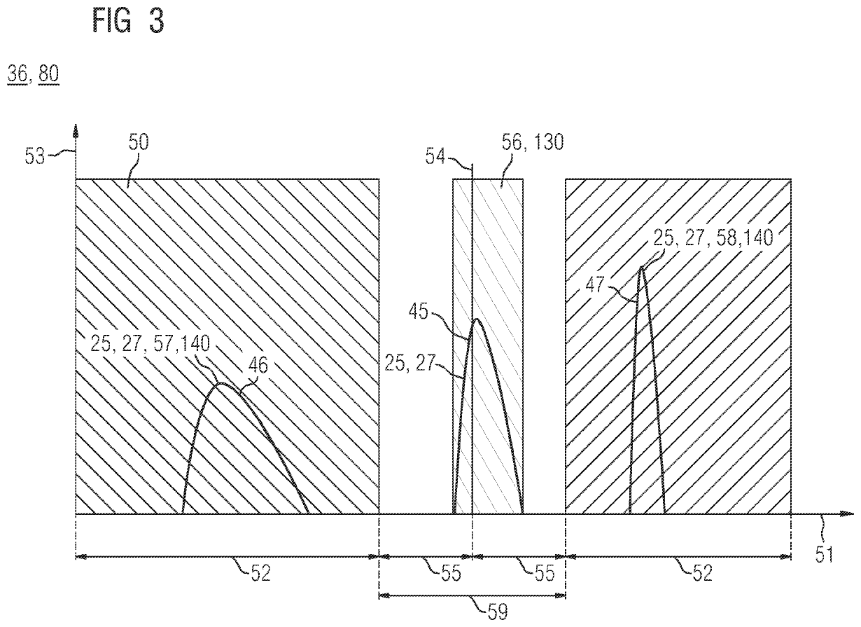

FIG. 3 shows a diagram 50 schematically illustrating the way in which the first interference filter 36 functions in a third and fourth step 130, 140 of the disclosed method 100. The diagram 50 has a horizontal wavelength axis 51 that indicates the present wavelength of a Raman radiation 25. The diagram 50 also has a vertical intensity axis 53 that indicates the intensity of the corresponding Raman radiation 25. The Raman radiation 10 has three peaks 45, 46, 47 having different wavelengths. Each of the peaks 45, 46, 47 essentially defines a Raman band 56, 57, 58. With regard to a first interference filter 36, a transmission section 59 in which the first interference filter 36 is permeable lies in a range of the first peak 45. The first peak 45 lies within a first Raman band 56, which can penetrate the first interference filter 36 and can be captured, for example, via a first receiving device 41, as shown in FIG. 1. The transmission range 59 has a central wavelength 54, which essentially defines a midpoint of the transmission section 59. The transmission section 59 is further defined by half widths 55 that extend on both sides of the central wavelength 54. In the case of the first interference filter 36, the central wavelength 54 is selected such that it coincides substantially with the first peak 45 and hence with the first Raman band 56. A raised transparency for the first Raman band 56 is therefore present in the first interference filter 36. The first Raman band 56 passes through in the third step 130 of the method 100, as shown inter alia in FIG. 2. The first Raman band 56 and the intensity that is present there are a measure of the concentration of a first component 16 of the substance sample 15 to be examined, as illustrated in FIG. 1.

The first interference filter 36 is structured to be impermeable in the range of the second and a third peak 46, 47. Owing to the oblique mounting of the first interference filter 36, a reflection of the Raman radiation 25 occurs outside the transmission section 59. The first, second and third peaks 45, 46, 47 belong to the same beam path 27 into which the Raman radiation 25 is directed. The associated reflection sections 52 are situated on both sides of the transmission section 59 along the wavelength axis 51. The Raman radiation 25 in the range of the second and third Raman band 57, 58 is reflected onto a second interference filter 37, as shown, for example, in FIG. 2. The reflection of the beam path 27 containing the second and third Raman bands 57, 58 takes place in a fourth step 140 of the disclosed method 100. The combination of reflecting and transmitting a beam path 27 containing Raman radiation 25 means that the first interference filter 36 is semi-permeable.

The transmission section 59 has half widths 55 of up to 20 nm in each case. It bears noting that only a small portion of the beam path 27 is allowed through the interference filter 36 in the third step 130. As a result, the interference filter 36 can be manufactured simply. A damaged first interference filter 36 immediately results in an unambiguously localizable error during operation of the associated Raman photometer 10, thereby increasing the ease of repair. Furthermore, the transmission and reflection behavior of the first interference filter 36 can be simulated easily and precisely by a computer program product 80. Therefore a defective first interference filter 36 can be reliably identified via the computer program product 80, which comprises a digital twin of the Raman photometer 10.

The structure and functioning of the third and fourth steps 130, 140 can readily be transferred to other wavelengths, for example, with the second or third peaks 46, 47 and therefore respectively the second and third Raman bands 57, 58 in the transmission section 59. The technical advantages of the embodiment shown in FIG. 3 are also obtained likewise for such corresponding embodiments.

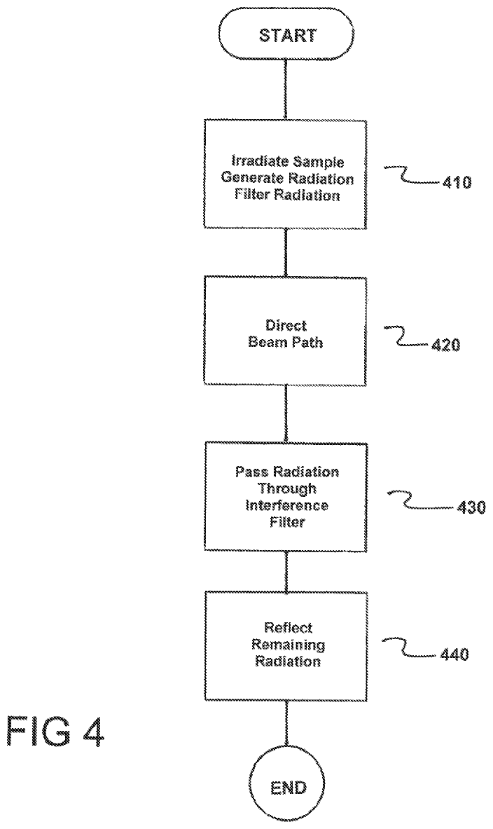

FIG. 4 is a flowchart of the method 100 for measuring a composition 19 of a substance sample 15 via a Raman photometer 10. The method comprises a) irradiating the substance sample 15 via an excitation light source 24, generating a Raman radiation 25 and spatially filtering the Raman radiation 25 via a slot diaphragm 49, as indicated in step 410.

Next, b) a beam path 27 of the Raman radiation 25 is optically directed onto a first interference filter 36, as indicated in step 420.

Next, c) part of the Raman radiation 25 is let through the first interference filter 36 to a first receiving device 41 which captures a first Raman band 56, as indicated in step 430.

Next, d) the remaining Raman radiation 25 at the first interference filter 36 is at least partially reflected to a second interference filter 37, as indicated in step 440.

In accordance with the inventive method, the second interference filter 37 is connected upstream of a second receiving device 42 which is configured to capture a second Raman band 57, and at least one of the first and second receiving device 41, 42 is operated without a cooling system.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. A Raman photometer comprising:
a base module having a measuring cell for generating Raman radiation by a substance sample;
at least one expansion module having at least one first semi-permeable interference filter for simultaneously capturing a first and a second component of the substance sample; and
a slot diaphragm arranged between the measuring cell and the first semi-permeable interference filter.

18. The Raman photometer as claimed in claim 17, further comprising:
at least one first receiving device arranged in the expansion module, said at least one first receiving device being formed as a strip.

19. The Raman photometer as claimed in claim 17, wherein the first interference filter comprises a band-pass filter for a first Raman band which is captured by the first receiving device.

20. The Raman photometer as claimed in claim 18, wherein the first interference filter comprises a band-pass filter for a first Raman band which is captured by the first receiving device.

21. The Raman photometer as claimed in claim 19, wherein the first interference filter is configured to reflect a beam path which is outside the first Raman band, the reflected beam path being directed to a second semi-permeable interference filter in the expansion module.

22. The Raman photometer as claimed in claim 17, wherein the expansion module includes at least three receiving devices which are each configured to receive a Raman band.

23. The Raman photometer as claimed in claim 17, wherein at least one receiving device of the at least three receiving devices comprises a photodetector.

24. The Raman photometer as claimed in claim 17, wherein at least one receiving device of the at least three of the receiving devices is configured to have no cooling system.

25. The Raman photometer as claimed in claim 17, wherein the measuring cell is configured to emit the beam path perpendicular to a beam direction of an excitation light source.

26. The Raman photometer as claimed in claim 25, wherein the excitation light source comprises a laser.

27. The Raman photometer as claimed in claim 26, wherein the laser has a central wavelength from 350 nm to 550 nm.

28. The Raman photometer as claimed in claim 17, wherein at least the first interference filter has a half width of up to 20 nm around a central wavelength.

29. The Raman photometer as claimed in claim 17, wherein at least one semi-permeable interference filter of the Raman photometer has a central wavelength from 350 nm to 555 nm.

30. The Raman photometer as claimed in claim 17, wherein the base module is connected to from two to six expansion modules.

31. A method for measuring a composition of a substance sample via a Raman photometer, the method comprising:
a) irradiating the substance sample via an excitation light source, generating a Raman radiation and spatially filtering the Raman radiation via a slot diaphragm;
b) optically directing a beam path of the Raman radiation onto a first interference filter;
c) passing part of the Raman radiation through the first interference filter to a first receiving device which captures a first Raman band; and
d) at least partially reflecting a remaining Raman radiation at the first interference filter to a second interference filter;
wherein the second interference filter is connected upstream of a second receiving device which is configured to capture a second Raman band; and
wherein at least one of the first and second receiving device is operated without a cooling system.

32. The method as claimed in claim 31, wherein capture of the first and second Raman bands occur essentially simultaneously.

33. A spectrometer system for capturing a composition of a substance sample, the spectrometer system comprising a Raman photometer and an evaluation unit which is connected thereto, wherein the Raman photometer is configured as claimed in claim 17.

34. A non-transitory computer readable medium encoded with program instructions which, when executed by a processor of a computer, causes the computer to simulate an operating behavior of a Raman photometer having a physics module which is configured to simulate a reflection behavior and transmission behavior of an interference filter, the Raman photometer comprising a base module having a measuring cell for generating Raman radiation by a substance sample, at least one expansion module having at least one first semi-permeable interference filter for simultaneously capturing a first and a second component of the substance sample, and a slot diaphragm arranged between the measuring cell and the first semi-permeable interference filter, the program instructions comprising:
a) program code for irradiating the substance sample via an excitation light source, generating a Raman radiation and spatially filtering the Raman radiation via a slot diaphragm;
b) program code for optically directing a beam path of the Raman radiation onto a first interference filter;
c) program code for passing part of the Raman radiation through the first interference filter to a first receiving device which captures a first Raman band; and
d) program code for at least partially reflecting a remaining Raman radiation at the first interference filter to a second interference filter;
wherein the second interference filter is connected upstream of a second receiving device which is configured to capture a second Raman band; and
wherein at least one of the first and second receiving device is operated without a cooling system.
